(19) United States
(12) Patent Application Publication
(10) Pub. No.: US 2008/0307217 A1
(43) Pub. Date: Dec. 11, 2008

(54) CONTENTS TRANSMITTING/RECEIVING APPARATUS AND METHOD

(76) Inventors: Takanori Yukimatsu, Kawasaki (JP); Hiroo Okamoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/927,772

(22) Filed: Oct. 30, 2007

(30) Foreign Application Priority Data
Oct. 30, 2006 (JP) 2006-294339

(51) Int. Cl. H04L 9/14; H04L 9/08

(52) U.S. Cl. 713/150; 380/278

(57) ABSTRACT

A contents transmitting apparatus includes an encryption algorithm storage section for storing a plurality of encryption algorithms; a key generation section for generating key information based on a mutual authentication result with a contents receiving apparatus; a control section for selecting one encryption algorithm from the encryption algorithm storage section and acquiring a key from the key information to provide it to an encryption section. The encryption section encrypts a content by use of a given encryption algorithm and a given key. During a period in which the generated key information is valid, a different encryption algorithm is selected from the encryption algorithm storage section every time a content to be transmitted is changed, and a different key is acquired from the key information for encryption.

### INCORPORATION BY REFERENCE

This application relates to and claims priority from Japanese Patent Application No. 2006-294339 filed on Oct. 30, 2006, the entire disclosure of which is incorporated herein by reference.

### BACKGROUND OF THE INVENTION

1. Field of the Invention

The present invention relates to a contents transmitting/receiving apparatus and a content encryption method that are suitable for protecting copyrights of video and audio contents transmitted and received through a network.

2. Description of the Related Arts

With the wide spread of a digital AV apparatus recently, a system has been introduced for recording digital video and audio data (hereinafter referred to as a content) received from a digital broadcasting etc., or transmitting a content to another AV apparatus through an in-home LAN (Local Area Network) to enable people to watch the content with an apparatus installed in a room. In this case, a digital content to be transmitted or received is often subject to copyright protection, so a technology is required to prevent illegal wiretapping of the content by a third party in the course of transmission. For example, copyright protection for preventing illegal wiretapping has been implemented. That is, when a content is transmitted between digital AV apparatus, a transmission side encrypts the content and share information for decryption with a reception side, so that the content is read only by a designated legitimate contents receiving apparatus (which is a source) and cannot be read illegally by other apparatus.

Such an encryption scheme is described in Japanese Patent Laid-Open No. 2000-287192, which disclosed a technology for defining an encryption extension header including attribute information related to encryption and transmitting it with a content in order to apply the copyright protection technique not only to IEEE 1394 but also to distribution of digital contents over a network such as Internet.

In addition, another Japanese Patent Laid-Open No. 2001-358706 disclosed a technology of preventing illegal decoding of digital contents, wherein data having the decoding limit such as the number of reproducing times is surely updated, and the decoding limited data is encrypted with a time varying key and shared, while in a secured state, by transmitting and receiving apparatuses.

### SUMMARY OF THE INVENTION

According to the conventional technologies described above, when a content is transmitted by way of a network, one encryption system is implemented to encrypt the content. That is, to start transmission and receiving operations, when a transmission side and a reception side authenticate each other, one encryption method (a common encryption key) is used while these apparatuses are being connected. In such case, if the encryption key is decoded by a third party in the course of transmission, all contents to be transmitted from that point are read and damages are increased. Moreover, in the case of transmitting one content to plural receiving apparatus, if each of the receiving apparatuses uses a common encryption key for the content, damages are done similarly. In order to prevent this, an encryption key may be changed little by little in the course of contents transmission. However, this approach is not really practical because it requires authentication of an apparatus and for creation of a new key, while interrupting the transmission. Also, an efficient encryption performance is required to change an encryption key for every receiving apparatus as a source of the same contents.

It is, therefore, an object of the present invention to provide a technique for suppressing damages by illegal wiretapping in the course of transmitting encrypted contents to a minimum, demonstrating a speedy and easy encryption.

One aspect of the present invention provides a contents transmitting apparatus for transmitting contents to another contents receiving apparatus via a network, including: a contents transmission section for transmitting a content to the contents receiving apparatus; an encryption section for encrypting a content to be transmitted by use of a given encryption algorithm and a given key; an encryption algorithm storage section for storing plural encryption algorithms for use in encryption; a key generation section for generating key information for use in encryption based on an authentication result with the contents receiving apparatus; and a control section for selecting one encryption algorithm from the encryption algorithm storage section, acquiring a key for use in the selected encryption algorithm from key information, and providing the key to the encryption section.

During a period in which the key information generated by the key generation section is valid, the control section selects a different encryption algorithm from the encryption algorithm storage section every time a content to be transmitted toward the receiving apparatus changes or every time a content is transmitted for a predetermined amount of time or a content of a predetermined size is transmitted; acquires a key for use in the selected encryption algorithm from key information; and provides the key to the encryption section.

Moreover, an exemplary embodiment of the present invention suggests that there are plural receiving apparatuses. For instance, suppose that a content transmission request is received from a second contents receiving apparatus in the course of transmitting a content toward a first receiving apparatus. During a period in which the key information generated by the key generation section is valid, the control section selects a different encryption algorithm from the encryption algorithm storage section so as to encrypt a content to be transmitted to the second contents receiving apparatus; acquires a key for use in each of the selected encryption algorithms from key information; and provides the key to the encryption section.

Another aspect of the present invention provides a contents receiving apparatus for receiving contents from another contents transmitting apparatus via a network, including: a contents reception section for receiving a content from the contents transmitting apparatus; a decryption section for decrypting a received content by use of a given encryption algorithm and a given key; an encryption algorithm storage section for storing plural encryption algorithms for use in decryption; a key generation section for generating key information for use in decryption based on an authentication result with the transmitting apparatus; and a control section for selecting a predetermined encryption algorithm from the encryption algorithm storage section based on encryption information included in a received content, acquiring a predetermined key from the key information, and providing the key to a decryption section.

Still another aspect of the present invention provides a content encryption method for encrypting a content to be transmitted from a contents transmitting apparatus to a receiving apparatus, including the steps of: generating key information for use in encryption based on an authentication result between the contents transmitting apparatus and the receiving apparatus; selecting an encryption algorithm from plural encryption algorithms; acquiring a key for use in the selected encryption algorithm from the key information; and encrypting a content to be transmitted by use of the selected encryption algorithm and the acquired key.

In accordance with the present invention, it is possible to change an applied encryption method quickly and easily. It is also possible to reduce damages by illegal wiretapping of contents to be transmitted to a minimum.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a configuration of a content transmitting/receiving system, which is implemented by one embodiment of the present invention;

FIG. 2 is a block diagram showing a configuration of an in-home LAN (3) for executing a content transmission/reception process;

FIG. 3 is a sequence diagram showing procedures for transmitting and receiving contents, which are implemented by a first embodiment of the present invention;

FIG. 4 is a sequence diagram showing procedures for encryption and decryption in the course of transmitting plural contents;

FIG. 5 is a diagram illustrating plural encryption algorithms being stored;

FIG. 6 is a diagram illustrating key information generated by a key generation section;

FIG. 7 is a diagram illustrating a format of an encrypted content;

FIG. 8 is a sequence diagram showing procedures for transmitting and receiving contents, which are implemented by a second embodiment of the present invention; and

FIG. 9 is a block diagram showing a configuration of a content transmitting/receiving system, which is implemented by a third embodiment of the present invention.

### DETAILED DESCRIPTION OF THE PREFERRED EMBODIMENT

Preferred embodiments of the present invention will now be described with reference to the accompanying drawings.

### Embodiment 1

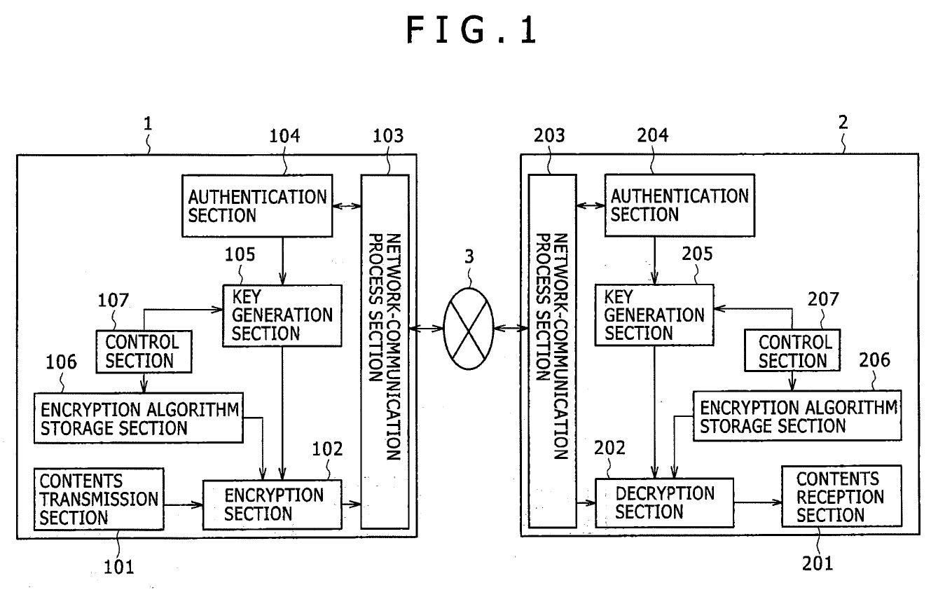

FIG. 1 is a block diagram showing a configuration of a content transmitting/receiving system, which is implemented by one embodiment of the present invention. In this system, a contents transmitting apparatus 1 and a contents receiving apparatus 2 are connected to each other via a LAN 3. In the case of this system, a broadcast receiver corresponding to the contents transmitting apparatus 1 transmits video and audio contents to a monitor corresponding to the contents receiving apparatus 2.

In the contents transmitting apparatus 1, a contents transmission section 101 transmits contents to the contents receiving apparatus 2. An encryption section 102 encrypts contents outputted from the contents transmission section 101. A network-communication process section 103 exchanges an output of an encryption section 102 and an input/output of an authentication section 104 with another apparatus (in this embodiment, the contents receiving apparatus 2) via the LAN 3. The authentication section 104 exchanges information with another apparatus to execute mutual authentications between apparatuses. A key generation section 105 generates key information based on information outputted from the authentication section 104 as a key to be used by the encryption section 102 to encrypt a content. An encryption algorithm storage section 106 stores or retains plural encryption algorithms for encryption. A control section 107 selects one encryption algorithm from the encryption algorithm storage section 106 to provide it to the encryption section 102. The control section 107 also provides the encryption section 102 with a key for use in the selected encryption algorithm, in which the key is acquired from the key information having been generated by the key generation section 105. The encryption section 102 encrypts a content by use of the given encryption algorithm and key.

On the other hand, in the contents receiving apparatus 2, a network-communication process section 203 exchanges an input to a decryption section 202 and an input/output of an authentication section 204 with another apparatus (in this embodiment, the contents transmitting apparatus 1) via the LAN 3. The decryption section 202 decrypts an encrypted content forwarded from the transmitting apparatus 1 to output it to a contents reception section 201. The authentication section 204 exchanges information with another apparatus to execute mutual authentications between apparatuses. A key generation section 205 generates key information based on information outputted from the authentication section 204 as a key to be used by the decryption section 202 to decrypt a content. This key information is the same as one generated by the key generation section 105 to the contents transmitting apparatus. An encryption algorithm storage section 206 stores or retains plural encryption algorithms for decryption. These encryption algorithms are the same as ones stored in the encryption algorithm storage section 106. A control section 207 selects one encryption algorithm from the encryption algorithm storage section 206 to provide it to the decryption section 202. The control section 207 also provides the decryption section 202 with a key for use in the selected encryption algorithm, in which the key is acquired from the key information having been generated by the key generation section 205. At this time, the decryption section 202 is provided with the same encryption algorithm and the same key that the transmitting apparatus 1 had selected and used based on the encryption information included in a content. The decryption section 202 decrypts a content by use of the given encryption algorithm and key.

The contents transmitting apparatus 1 of this embodiment is characterized in that the encryption algorithm storage section 106 stores or retains plural encryption algorithms, an encryption algorithm is variably selected for each content to be transmitted, and a key used for encryption is acquired from key information. In addition, the contents receiving apparatus 2 of this embodiment is characterized in that the encryption algorithm storage section 206 retains the same number of encryption algorithms on the transmission side, an encryption algorithm matching with a transmitted content is selected, and a key used for the decryption is acquired from the same key information on the transmission side. As a result, if one content being transmitted may be wiretapped by a third party, it is difficult to decode a next content because its encryption condition has changed, thereby suppressing damages to a minimum.

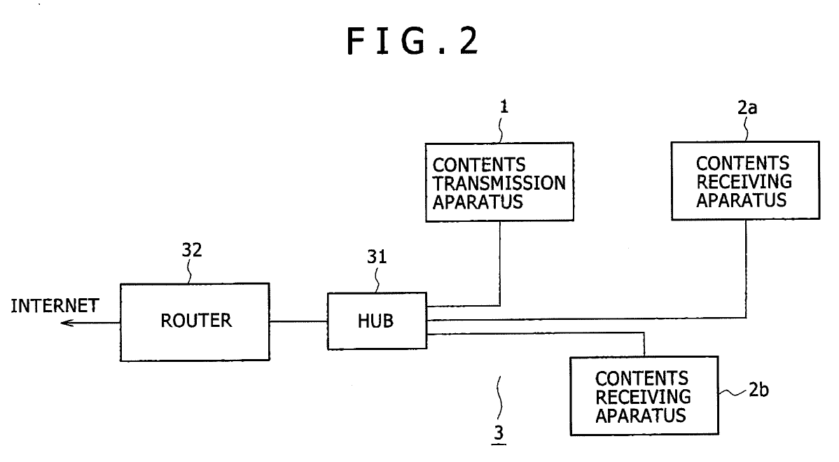

FIG. 2 is a block diagram showing a configuration of an in-home LAN (3) for executing a content transmission/reception process between apparatuses. One contents transmitting apparatus 1 and two contents receiving apparatuses 2a and 2b are connected respectively to a network hub device 31 via a wired LAN 3 cable. The network hub device 31 is connected to a router 32 and to Internet through a modem or an O/E converter. The contents transmitting apparatus 1, the contents receiving apparatuses 2a and 2b, and the router 32 have their own IP address for identifying themselves over the LAN. In addition, a 48-bit MAC (Media Access Control) address is assigned in advance to an interface of a network-communication process section in each device during its manufacture. The IP address for each apparatus is set in accordance with a DHCP (Dynamic Host Configuration Protocol) widely adopted as a protocol for automatically setting addresses in a network. With an application of the DHCP, for example, the router is operated as a DHCP server, which then assigns an IP address for each apparatus. Moreover, if an IPv6 (Internet Protocol Version 6) is used, according to a method known as a stateless automatic setting, each apparatus may determine its own IP address in use of 64 high-order bits of an IP address of the router 32 and a MAC address. Although it has been assumed in this embodiment that each apparatus is connected to an in-home LAN, the present invention is not limited thereto but can be applied to a content transmission/reception process with an apparatus outside the home via Internet.

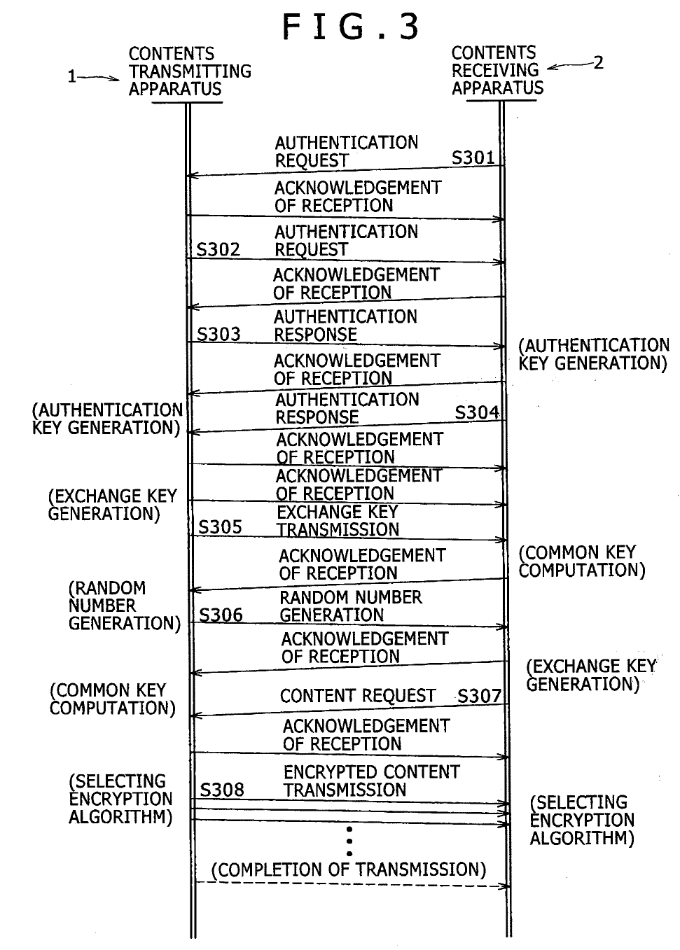

FIG. 3 is a sequence diagram showing procedures for transmitting and receiving contents, according to this embodiment of the present invention.

At first, the contents receiving apparatus 2 creates an authentication request. The authentication request specifies a public key intrinsic or unique to the contents receiving apparatus 2 and a certificate of the public key, which are issued by a specific authentication agency and is transmitted to the contents transmitting apparatus 1 (S301). Upon receiving the authentication request, the contents transmitting apparatus 1 returns an ack (acknowledgement) of the reception of the authentication request to the contents receiving apparatus 2. Then, the contents transmitting apparatus 1 creates its own authentication request, and similarly to the contents receiving apparatus 2, transmits to the contents receiving apparatus 2 the authentication request including a public key unique to the contents transmitting apparatus 1 and a certificate of the public key (S302). Receiving the authentication request, the contents receiving apparatus 2 returns an ack of the reception of the authentication request to the contents transmitting apparatus 1.

Upon receiving the authentication request from the contents receiving apparatus 2, the contents transmitting apparatus 1 authenticates the contents receiving apparatus 2 based on a predetermined public key signature algorithm. If the authentication succeeds, the contents transmitting apparatus 1 issues an authentication response to transmit it toward the contents receiving apparatus 2 (S303). Likewise, upon receiving the authentication request from the contents transmitting apparatus 1, the contents receiving apparatus 2 executes the authentication process. If the authentication succeeds, the contents receiving apparatus 2 issues an authentication response to transmit it toward the contents transmitting apparatus 1 (S304). If the mutual authentications are successful, each apparatus creates a common authentication key to be shared. A commonly known key exchange algorithm such as the Diffie-Hellman key agreement protocol may be adopted in creation of the authentication key.

When the process of sharing the authentication key is completed, the contents transmitting apparatus 1 generates an exchange key and a random number, encrypts the exchange key and the random number by use of the authentication key, and transmits the encrypted exchange key and the encrypted random number to the contents receiving apparatus 2 (S305 and S306). At this time, the exchange key and the random number may be transmitted in combined data. The contents receiving apparatus 2 decrypts the transmitted exchange key and random number transmitted from the contents transmitting apparatus 1 by use of the authentication key and stores the decrypted exchange key and random number. Subsequently, the contents transmitting apparatus 1 and the contents receiving apparatus 2 respectively use the exchange key and the random number to generate a common key in accordance with a predetermined computation algorithm.

When a content transmission request is sent from the contents receiving apparatus 2 to the contents transmitting apparatus 1 (S307), the contents transmitting apparatus 1 selects an encryption algorithm having been stored and encrypts a content by the common key to transmit it to the contents receiving apparatus 2 (S308). Meanwhile, the contents receiving apparatus 2 decrypts the received encrypted content by the encryption algorithm and the common key.

The common key mentioned here indicates the “key information” described earlier and is shared only by a completely authenticated contents transmitting apparatus 1 and a completely authenticated contents receiving apparatus 2, so it is highly concealed. Moreover, with a selected encryption algorithm, there is less risk of wiretapping of contents. More details on this are provided hereinafter.

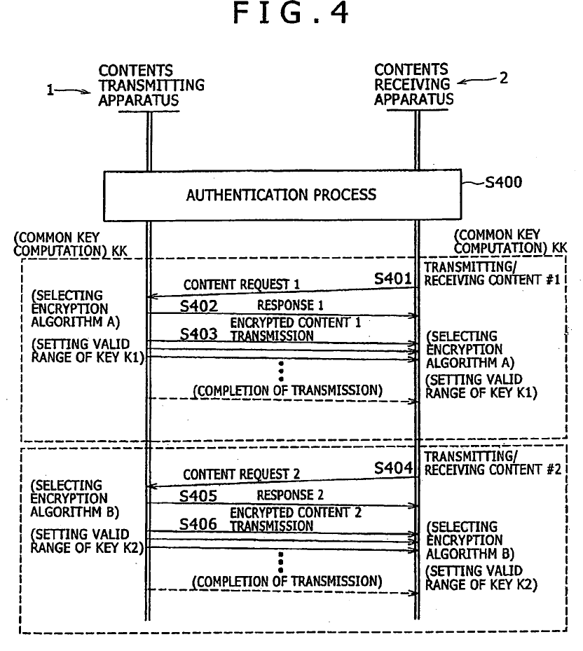

FIG. 4 is a sequence diagram showing procedures for encryption and decryption in the course of transmitting plural contents in FIG. 3. First, at the result of authentication process, the contents transmitting apparatus 1 and the contents receiving apparatus 2 share a common key (key information) KK for use in encryption and decryption of contents (S400). There is a period in which the use of the common key KK is valid. And, it is assumed that plural contents (#1 and #2) of a broadcast program for example are transmitted one by one while the common key KK can be validly used.

When the contents transmitting apparatus 1 receives a transmission request of the contents (#1) from the contents receiving apparatus 2 (S401), it returns an ack of the receipt (S402). Then, the contents transmitting apparatus 1 selects one (e.g., an algorithm A) of the plural encryption algorithms stored in the encryption algorithm storage section 106, and sets a valid range of the common key KK generated by the key generation section 105. A valid range indicates an acquisition position for acquiring a key k1 to be used for the actual encryption from the common key KK. Further, the encryption section 102 encrypts the contents (#1) by use of the selected encryption algorithm and the valid range (key K1) of the common key having been set. The encrypted contents (#1) are sequentially transmitted from the network-communication process section 103 (S403).

When the contents receiving apparatus 2 receives the encrypted contents (#1), the decryption section 202 decrypts the contents (#1). For decryption, the contents receiving apparatus 2 selects one (e.g., an algorithm A) of the plural encryption algorithms stored in the encryption algorithm storage section 206, and sets a valid range (key K1) of the common key KK generated by the key generation section 205. At this time, since an encryption algorithm to be selected and the valid range of the common key to be set up are already added to the contents (#1) to be received as encryption information, selection may be made accordingly.

After completing the transmission of the contents (#1), the contents transmitting apparatus 1 receives, during the valid period for use of the common key KK, a transmission request of next contents (#2) from the contents receiving apparatus 2 (S404), and returns an ack of the reception (S405). The contents transmitting apparatus 1 selects another encryption algorithm (e.g., algorithm B) being stored in the encryption algorithm storage section 106. Also, it sets again a valid range (key K2) among the common key KK generated by the key generation section 105. In this case, although it is not absolutely required to make the key K2 different from the previous key K1, the stability increases by doing so. Then, the encryption section 102 encrypts the contents (#2) by use of the changed encryption algorithm (i.e., algorithm B) and the valid range (key K2) of the common key. The encrypted contents (#2) are sequentially transmitted from the network-communication process section 103 (S406).

When the contents receiving apparatus 2 receives the encrypted contents (#2), the decryption section 202 decrypts the contents (#2). In this case, again, an encryption algorithm (algorithm B) to be selected and the valid range of the common key to be set up are already added to the contents (#2) to be received as encryption information, switching may be done accordingly.

The following now describes in detail a method of acquiring an encryption algorithm from the encryption algorithm storage section 106 or 206 and a method of acquiring a key from a common key (key information) generated by the key generation section 105 or 205.

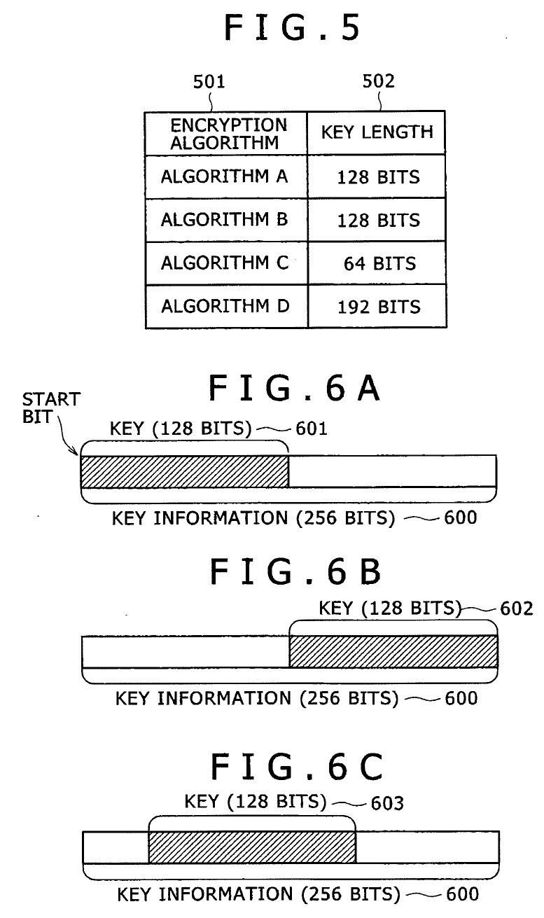

FIG. 5 is a diagram illustrating plural encryption algorithms stored in the encryption algorithm storage section 106 or 206. Item 501 indicates kinds of encryption algorithms. In this case, four kinds of encryption algorithms (Algorithm A, B, C, and D) for example are stored. Item 502 indicates key length (bit number) of a key required for using each encryption algorithm. The table illustrates the use of different key lengths (e.g., 128, 128, 64, and 192 bits).

That is to say, if the control section 107 or 207 selects an algorithm A from the encryption algorithm storage section 106 or 206 for use in encryption/decryption of a content, it needs to acquire a 128-bit key from the key information generated by the key generation section 105 or 205.

FIG. 6 is a diagram illustrating key information generated by the key generation section 105 or 205. In this example, it is assumed that key information 600 has a key length of 256 bits, and a 128-bit key is to be acquired therefrom. FIG. 6A illustrates a case where 128 high-order bits of the key information 600 are assigned as a key 601; FIG. 6B illustrates a case where 128 lower-order bits of the key information 600 are assigned as a key 602; and FIG. 6C illustrates a case where 128 bits at a random position of the key information 600 are assigned as a key 603. Therefore, a totally new key can easily be created by referring to the same key information 600 and changing its acquisition position.

If the control section 107 of the contents transmitting apparatus 1 selects the algorithm A shown in FIG. 5 for example from the encryption algorithm storage section 106, it acquires the key 601 of 128 high-order bits shown in FIG. 6A from the key information 600 generated by the key generation section 105. Then, it provides the acquired encryption algorithm A and key 601 to the encryption section 102. The encryption section 102 encrypts a content outputted from the content transmitting section 101 by use of the algorithm A and the key 601. The contents receiving apparatus 2 decrypts a content in the same order by use of the algorithm A and the key 601.

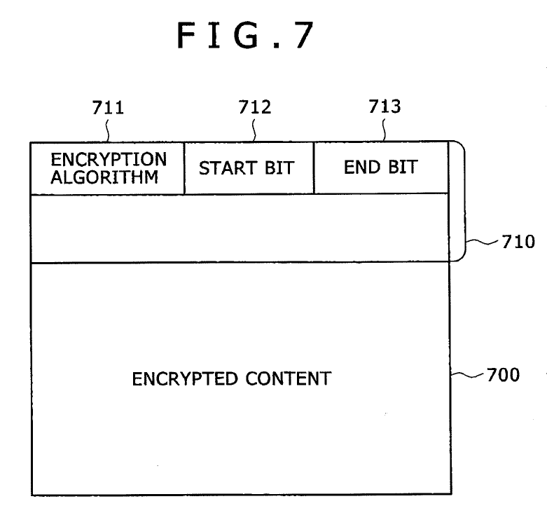

FIG. 7 is a diagram illustrating a format of an encrypted content to be transmitted from the contents transmitting apparatus 1 to the contents receiving apparatus 2. The content being transmitted is composed of an encryption content 700 attached by an encrypted header 710 describing encryption information. The encrypted header 710 contains information about a kind of encryption algorithm 711 and a start bit 712 and an end bit 713 of a key acquisition position. The kind of encryption algorithm 711 identifies an encryption algorithm stored in the encryption algorithm storage section 106 or 206. For instance, the algorithm A may be defined as “0×01”, and the algorithm B may be defined as “0×02”. The start bit 712 and the end bit 713 indicate which range of the key information 600 is going to be assigned as a key. In the case of FIG. 6A, 128 high-order bits of the key information 600 are used, so the start bit 712 is described as “0” and the end bit 713 is described as “127”. The encrypted header 710 may include copy restriction information such as “Copy Never”, “Copy Once”, etc., or an encryption content length to which the encrypted header 710 is validly applied.

Upon receiving a content, the contents receiving apparatus 2 interprets the encryption information of the encrypted header 710, and decrypts the encrypted content accordingly. The control section 207 acquires a predetermined encryption algorithm from the encryption algorithm storage section 206 based on the information about the kind of encryption algorithm 711. In addition, the contents receiving apparatus 2 acquires a predetermined key from the key information generated by the key generation section 205 based on the information about the acquisition position of the start bit 712 and the end bit 713 and provides the acquired key to the decryption section 202. Then, the decryption section 202 decrypts an encrypted content forwarded from the network-communication process section 203 by use of the encryption algorithm and the key, and outputs the decrypted content to the contents receiving apparatus 201.

Therefore, according to this embodiment, an encryption algorithm changes whenever a content to be transmitted changes. Moreover, changing a common key (key information and a valid range (acquisition position) for a key to be used in encryption exerts practically the same effect as using a totally new key. In a conventional method, every time a content transmission request is made, authentication process had to be performed between apparatuses to generate a new common key. This has inevitably led to delay in the start of content transmission or interruption of the transmission. On the contrary, this embodiment makes it possible to change encryption algorithm and key quickly and easily without a new authentication process between apparatuses. In addition, contents can be transmitted more safely by changing the encryption method per content.

Although in this embodiment an encryption algorithm is changed whenever a content (program) to be transmitted changes, the present invention is not limited thereto. That is, an encryption algorithm may be changed when a format of a content is changed from a video film such as an MPEG file to an image file such as a JPEG file. Moreover, an encryption algorithm may be changed when either a content of a predetermined time was transmitted or when a content of a predetermined size was transmitted.

### Embodiment 2

This embodiment involves the transmission system of FIG. 2, in which a content is transmitted from the contents transmitting apparatus 1 to plural contents receiving apparatuses 2a and 2b.

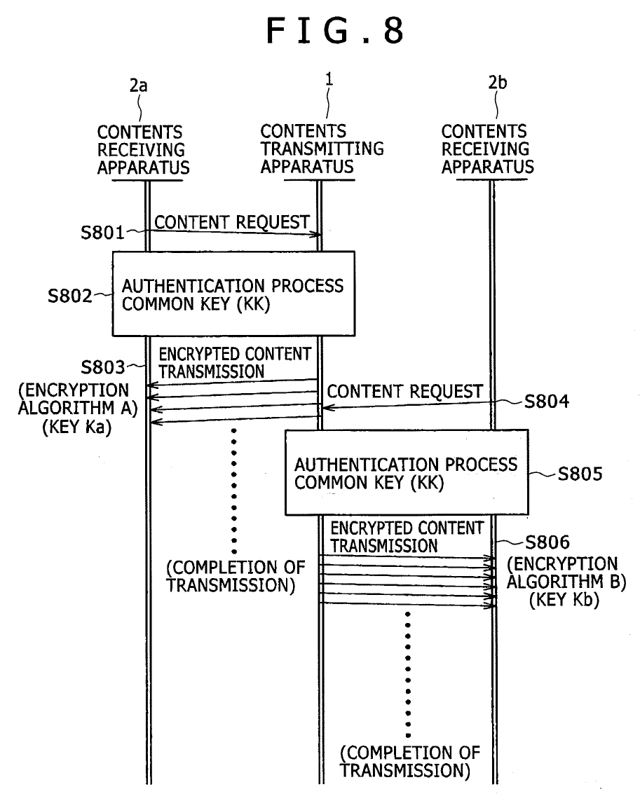

FIG. 8 is a sequence diagram showing procedures for transmitting and receiving contents, in accordance with this embodiment. It is assumed that while an encrypted content is transmitted from the contents transmitting apparatus 1 to the contents receiving apparatus 2a, the other contents receiving apparatus 2b makes a content transmission request to the contents transmitting apparatus 1. In other words, this is a case where a content transmission request is sent again to the contents receiving apparatus 2b while a common key shared by the contents transmitting apparatus 1 and the contents receiving apparatus 2a is yet within a valid period.

First, the contents transmitting apparatus 1 receives a content transmission request from the contents receiving apparatus 2a (S801). The mutual authentication process is carried out between the contents transmitting apparatus 1 and the contents receiving apparatus 2a, and if the authentication is successful the apparatuses generate a common key (key information) KK (S802) The contents transmitting apparatus 1 selects an algorithm A and encrypts a content by use of a key Ka acquired from the common key KK to transmit the content to the contents receiving apparatus 2a (S803). Then, the contents receiving apparatus 2a receives the encrypted content and decrypts the content by use of the algorithm A and the key Ka acquired from the common key KK. Here, selection of an encryption algorithm, key acquisition, and transmission of encryption information between the contents transmitting apparatus 1 and the contents receiving apparatus 2a are carried out by the same method described in Embodiment 1.

Next, the contents transmitting apparatus 1 receives a content transmission request from another contents receiving apparatus 2b while it is transmitting a content to the contents receiving apparatus 2a (S804). The mutual authentication process is performed between the contents transmitting apparatus 1 and the contents receiving apparatus 2b, and if the authentication is successful the apparatuses generate a common key (key information) KK which is the same as the one shared between the contents transmitting apparatus 1 and the contents receiving apparatus 2a (S805) This is made possible by the contents transmitting apparatus 1 transmitting information for generating the same common key KK to the contents receiving apparatus 2b. And the contents transmitting apparatus 1 selects a different algorithm B and encrypts a content by use of a different key Kb acquired from the common key KK to transmit the content to the contents receiving apparatus 2b (S806). Then, the contents receiving apparatus 2b receives the encrypted content and decrypts it by use of the algorithm B and the key Kb acquired from the common key KK. In this case, although it is not absolutely required to make the key Kb different from the previous key Ka, the stability increases by doing so.

According to this embodiment, a content to be transmitted is encrypted by changing an encryption algorithm and a key while a common key is yet within a valid period for the contents receiving apparatus 2a and the contents receiving apparatus 2b, each as a source. At this time, a common key (key information) obtained from the authentication process is shared by the contents transmitting apparatus 1, the contents receiving apparatus 2a, and the contents receiving apparatus 2b, respectively. Thus, a key can easily be changed by changing a valid range (a start bit and an end bit) acquired from the use of the same common key. Incidentally, in a conventional transmission method, a contents transmitting apparatus encrypts contents to be transmitted to plural contents receiving apparatuses, by use of the same encryption algorithm and the same key. Compared with this, this embodiment features a safe transmission of contents.

### Embodiment 3

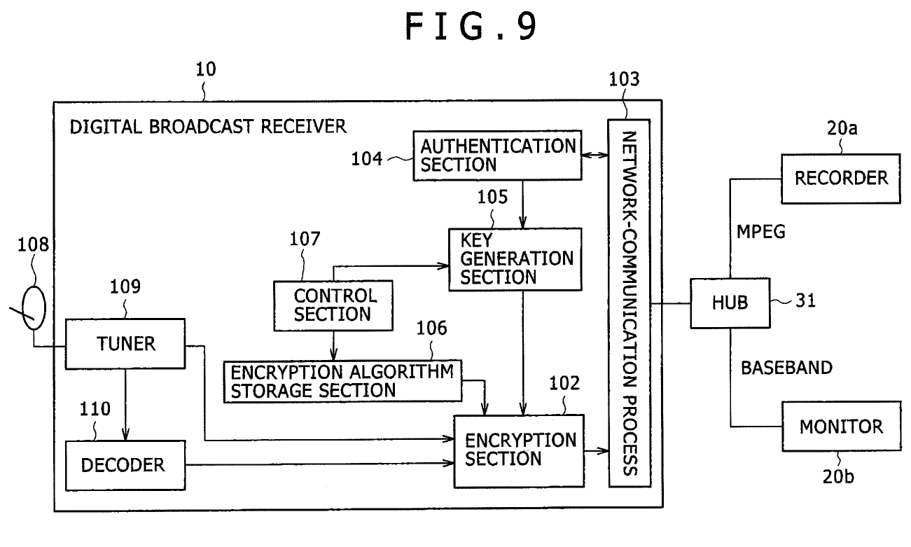

FIG. 9 is a block diagram showing a configuration of a content transmitting/receiving system implemented as an example of the Embodiment 1 and the Embodiment 2 for transmitting video and audio data from a broadcast receiver to a recorder and a monitor. This system includes a digital broadcast receiver 10 as a contents transmitting apparatus, and a recorder 20a and a monitor 20b as contents receiving apparatuses, each of which is connected to IP network via a hub 31.

The digital broadcast receiver 10 includes a digital broadcast receiving antenna 108, a tuner 109, and a decoder 110, in addition to the encryption process function illustrated in FIG. 1. In this example, there are two systems for content transmission. First of all, when the digital broadcast receiver 10 transmits a content (video and audio data broadcasted) toward the recorder 20a, the tuner 109 tunes in an MPEG-TS content having been received through antenna 108, an encryption section 102 encrypts the content, and a network-communication process section 103 transmits the encrypted content toward the recorder 20a. In addition, when the digital broadcast receiver 10 transmits a content toward the monitor 20b, the decoder 110 decodes the received MPEG-TS content, the encryption section 102 encrypts the content, and the network-communication process section 103 transmits the encrypted content toward the monitor 20b. At this time, the encryption section 102 encrypts two kinds of contents. That is, the content to be transmitted toward the recorder 20a is MPEG data, while the content to be transmitted to the monitor 20b is baseband data. Both are substantially different from each other in terms of the amount of data (band width) to be transmitted.

Similar to the Embodiment 2, the encryption section 102 in this embodiment uses different encryption algorithms for encrypting a content to be transmitted to the recorder 20a and encrypting a content to be transmitted to the monitor 20b. Since the content to be transmitted to the recorder 20a is MPEG data featuring a small amount of data, a complex encryption algorithm (heavy process), e.g., AES or DES block cipher, is adopted. Meanwhile, since the content to be transmitted to the monitor 20b is baseband data featuring a large amount of data, a simple encryption algorithm (light process), e.g., stream cipher, is adopted. As a result, a difference in the amounts of data (band width) for transmission after encryption in both cases is reduced, and both contents can be transmitted efficiently through a common interface.

Incidentally, a conventional method used the same encryption algorithm for plural transmission systems. In doing so, although an encrypted content could normally be transmitted towards the recorder 20a, the transmission process toward the monitor 20b got heavy, ending up in a failure of normal display of images. As a countermeasure, two interface systems, each corresponding to an amount of data for the recorder 20a and the monitor 20b, had to be installed. Contrarily, this embodiment suggests that contents may be encrypted by properly changing encryption algorithm, whereby the number of interfaces can be reduced and an interface can be used more efficiently.

As has been explained above, each embodiment of the present invention introduces a safer way of transmitting encrypted contents via a network by variably changing encryption algorithm if a content to be transmitted is changed or if a content transmission request is issued by another apparatus in the course of content transmission, changing a key to be acquired from key information generated during authentication, and using the changed key for encryption. A moment for changing the encryption method is not limited to the cases in the above descriptions. For example, it may be when a content is transmitted for a certain amount of time or when a content of a certain size is transmitted. Thus damages by illegal wiretapping can be suppressed to a minimum. Moreover, as the change in the encryption method depends on switching from plural encryption algorithms and setting of a valid range for key information, the changing procedure overall can be performed quickly and easily.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A contents transmitting apparatus for transmitting a content to another contents receiving apparatus via a network, comprising:
a contents transmission section for transmitting a content to the contents receiving apparatus;
an encryption section for encrypting the content to be transmitted by use of a given encryption algorithm and a given key;
an encryption algorithm storage section for storing a plurality of encryption algorithms for use in encryption;
a key generation section for generating key information for use in encryption based on an authentication result with the contents receiving apparatus; and
a control section for selecting one encryption algorithm from the encryption algorithm storage section, acquiring a key for use in the encryption algorithm from the key information, and providing the key to the encryption section.

2. The contents transmitting apparatus of claim 1, wherein during a period in which the key information generated by the key generation section is valid, the control section selects a different encryption algorithm from the encryption algorithm storage section every time a content to be transmitted toward the contents receiving apparatus changes or every time a content is transmitted for a predetermined amount of time or a content of a predetermined size is transmitted; acquires a key for use in the selected encryption algorithm from the key information; and provides the key to the encryption section.

3. The contents transmitting apparatus of claim 1, wherein the contents receiving apparatus exists in plural numbers, and if a content transmission request is received from a second contents receiving apparatus in the course of transmitting a content toward a first contents receiving apparatus, the control section selects a different encryption algorithm from the encryption algorithm storage section so as to encrypt a content to be transmitted to the second contents receiving apparatus; acquires a key to be used for the selected encryption algorithm from the key information; and provides the key to the encryption section, during a period in which the key information generated by the key generation section is valid.

4. The contents transmitting apparatus of claim 1, wherein if a different encryption algorithm is selected from the encryption algorithm storage section by the control section, a different key is acquired from the key information as a key for use in the selected encryption algorithm.

5. The contents transmitting apparatus of claim 1, wherein an encrypted content being transmitted toward the contents receiving apparatus contains encryption information about kind of encryption algorithm used for the encryption and acquisition position of a key being acquired from the key information.

6. A contents receiving apparatus for receiving a content from another contents transmitting apparatus via a network, comprising:
a contents reception section for receiving a content from the contents transmitting apparatus;
a decryption section for decrypting the received content by use of a given encryption algorithm and a given key;
an encryption algorithm storage section for storing a plurality of encryption algorithms for use in decryption;
a key generation section for generating key information for use in decryption based on an authentication result with the contents transmitting apparatus; and
a control section for selecting a predetermined encryption algorithm from the encryption algorithm storage section based on encryption information contained in the received content, acquiring a predetermined key from the key information, and providing the key to the decryption section.

7. A content encryption method for encrypting a content to be transmitted from a contents transmitting apparatus to a contents receiving apparatus, comprising the steps of:
generating key information for use in encryption based on an authentication result between the contents transmitting apparatus and the contents receiving apparatus;
selecting one encryption algorithm from a plurality of encryption algorithms;
acquiring a key for use in the selected encryption algorithm from the key information; and
encrypting a content to be transmitted by use of the selected encryption algorithm and the acquired key.
